(19) United States
(12) Patent Application Publication
(10) Pub. No.: US 2014/0263744 A1
(43) Pub. Date: Sep. 18, 2014

(54) APPARATUS FOR DEPOSITING INGREDIENT

(71) Applicant: Daniel Mark Ulledahl, Kansas City, MI (US)

(72) Inventor: Daniel Mark Ulledahl, Kansas City, MI (US)

(21) Appl. No.: 13/796,957

(22) Filed: Mar. 12, 2013

(51) Int. Cl. A23P 1/08

(52) U.S. Cl. CPC A23P 1/085; A23P 1/087
USPC 239/373; 239/302

(57) ABSTRACT

An apparatus for depositing an ingredient into or onto an edible article, the apparatus comprising a container configured to hold the ingredient, and a manifold configured to receive at least one discrete intake flow of the ingredient and to distribute at least two discrete output flows of the ingredient.

### FIELD OF INVENTION

The present invention relates generally to an apparatus for depositing an ingredient into or onto an edible article, the apparatus comprising a container configured to hold the ingredient, a manifold configured to receive at least one discrete intake flow of ingredient, and to distribute at least two discrete output flows of ingredient. Other aspects and advantages of the present invention will be apparent from the following detailed description of the embodiments and the accompanying drawings.

### BRIEF DESCRIPTION OF THE DRAWINGS

Several embodiments of the invention are described in detail below with reference to the attached drawings, wherein:

FIG. 1 illustrates a perspective view of an exemplary apparatus and edible article, in accordance with an embodiment of the invention; and

FIG. 2 illustrates a perspective view of a manifold and protrusions in accordance with an embodiment of the invention.

### DETAILED DESCRIPTION OF EMBODIMENTS

The present invention is to an apparatus 100 for depositing an ingredient 102 into or onto an edible article 104. The apparatus 100 comprising a container 10 configured to hold the ingredient 102, a manifold 12 configured to receive at least one discrete intake flow of the ingredient 102, and to distribute at least two discrete output flows of the ingredient 102.

The ingredient 102 can be any type of edible substance, including sauce, spice, dairy product, brine, icing, juice, oil, water, food coloring, preservative, additive, or mixed substance. The edible article 104 can be any type of edible substance or dish, including meat, fish, pastry, bread, cake, vegetable, fruit, sandwich, candy, and pet food.

The container 10 can be an open or closed vessel capable of holding the ingredient 102, such as a tank, canister, bottle, keg, barrel, bucket, bowl, jar, jug, bag, tube, cylinder, can, or vat. The container 10 can be of industrial size for large operations in restaurants and factories, or the container 10 can be small enough for personal use and can be portable such as a gallon jug. The container 10 can be reusable, resealable, or intended for one-time use and disposable. Reusable and resealable containers 10 can be washable and refillable for repeat use.

The container 10 can be made out of any number of materials, including metal, ceramic, glass, wood, and synthetic materials such as plastic and Styrofoam®. When used with ingredients 102 for human consumption, the container 10 should be made of a food-safe material. Reusable and resealable containers 10 can be made out of dishwasher safe material for more convenient cleaning.

The container 10 is generally configured to dispense ingredient 102. The container 10 may be gravity fed, such that gravity induces at least one discrete intake flow, in which case the container 10 may be a closed structure with an opening to the bottom or open to the top and pourable to selectively induce gravity feed. Alternatively, the container 10 may be pressurized, wherein the pressure difference between the container 10 and the edible article 104 induces the flow. The container 10 may be irreversibly pressurized, such as in the case of disposable canisters, or configured to be repeatedly pressurized. As shown in FIG. 1, the container 10 may include a pump 14 and pump handle 16, and thus operable to be hand-pumped and selectively pressurized. Alternatively, the container 10 may be continuously pressurized by an automatic pump or the ingredient 102 may be fed by an automatic pump.

The manifold 12 may be directly attached to the container 10 or the apparatus 100 may include a conduit 18, attached to the container 10 and the manifold 12, as shown in FIG. 1. The conduit 18 defines a dispensing channel 20 (FIG. 2) through which the ingredient 102 is dispensed. The conduit 18 may flexible, as shown in FIGS. 1-2, or rigid, and may be made of any number of materials including metal, ceramic, glass, wood, and synthetic materials such as plastic and Styrofoam®.

As exemplified in FIGS. 1-2, the apparatus 100 may include a valve 22 operable to selectively stop and start the flow of ingredient 102. The valve 22 may be controlled by a controller such as in a factory computer or may be hand controlled. The valve 22 may be configured to start the flow of ingredient 102 when a hand-generated force is applied, and to automatically stop the flow of ingredient 102 when the force is removed.

As shown in FIG. 2, the manifold 12 includes an intake channel 24 operable to receive the flow of ingredient 102 from the container 10 or conduit 18, a distribution channel 26 operable to divide the at least one discrete intake flow into at least two discrete output flows, and an output channel 28 operable to deliver the at least two discrete output flows. The intake channel 24 is generally aligned with the dispensing channel 20. The manifold 12 may be detachable from the container 10 or conduit 18. Those skilled in the art will readily understand that the manifold 12 may be created from any number of manufacturing methods, including milling, lathing, machining, molding, and carving. The manifold 12 can be made of any number of materials including metal, ceramic, glass, wood, and synthetic materials such as plastic and Styrofoam®.

The apparatus 100 may include at least one deposit protrusion 30 operable to deposit ingredient 102 into or onto the edible article 104. The deposit protrusions 30 each include a deposit channel 32 through which one of the at least two discrete output flows are delivered to the edible article 104. Each deposit channel 32 is generally aligned with an output channel 28. The deposit protrusions 30 each define a diameter and length, and the deposit protrusions 30 may present a needle-like structure such that the diameter to length aspect ratio is 0.2 at most. The deposit protrusions 30 further present a distal end, and the distal end may be angled, as shown in FIG. 2, to facilitate penetrating the edible article 104. The deposit protrusions 30 may be spaced any distance apart but for reference are spaced 0.5 inches apart in FIG. 2.

The deposit protrusions 30 and at least a portion of the manifold 12 may be formed of a single unitary body, and the manifold 12 may be configured to at least partially be dismantled for the purpose of maintenance or cleaning. Alternatively, the deposit protrusions 30 may be detachable from the manifold 12. The deposit protrusions 30 and manifold 12 may present male-to-female style connections. The connections may further be screw-type such that the deposit protrusions 30 screw into the manifold 12.

The embodiments of the present invention and the modes of operation described above are to be considered illustrative only, and should not be utilized in a limiting sense in interpreting the scope of the present invention. Obvious modifications to the exemplary embodiments, as set forth above, could be readily made by those skilled in the relevant arts without departing from the spirit of the present invention or the contemplated scope of protection.

What is claimed is:

1. An apparatus for depositing an ingredient into or onto an edible article, the apparatus comprising:
a container configured to hold the ingredient; and
a manifold configured to receive at least one discrete intake flow of the ingredient, and to distribute at least two discrete output flows of the ingredient.

2. The apparatus as claimed in claim 1, wherein the container is operable to be pressurized, and the intake flow of the ingredient is at least partially created by a difference in pressure between the container and the edible article.

3. The apparatus as claimed in claim 1, wherein the apparatus is portable.

4. The apparatus as claimed in claim 3, wherein the container includes a hand-powered pump operable to selectively pressurize the container.

5. The apparatus as claimed in claim 1, wherein the apparatus further comprises a conduit defining a distribution channel and presenting proximate and distal ends, wherein the proximate end is attached to the container and the distal end is attached to the manifold, and the conduit and channel are cooperatively operable to deliver the at least one discrete intake flow from the container to the manifold.

6. The apparatus as claimed in claim 1, wherein the apparatus further comprises a valve operable to selectively stop or start the distribution of the at least one discrete intake flow.

7. The apparatus as claimed in claim 6, wherein the valve is hand-operated and configured to selectively start the distribution of the at least one discrete intake flow when an external hand-generated force is applied to the valve, and to automatically stop the distribution of the at least one discrete intake flow when the external hand-generated force is removed.

8. The apparatus as claimed in claim 1, wherein the manifold includes an intake channel operable to receive the at least one discrete intake flow, a distribution channel operable to divide the at least one discrete intake flow into the at least two discrete output flows, and at least two output channels operable to deliver the at least two discrete output flows.

9. The apparatus as claimed in claim 8, further comprising at least two deposit protrusions, wherein the at least two deposit protrusions each define a deposit channel, and the deposit protrusions and deposit channels are cooperatively operable to deposit the at least two discrete output flows of ingredient into or onto the edible article.

10. The apparatus as claimed in claim 9, wherein the deposit channels are spaced at least 0.5 inches from one another.

11. The apparatus as claimed in claim 9, wherein the at least two deposit protrusions each present a distal end, and the distal end is angled.

12. The apparatus as claimed in claim 9, wherein the deposit protrusions and at least a portion of the manifold are formed of a single molded body.

13. The apparatus as claimed in claim 9, wherein the deposit protrusions each define a diameter and a length, and the diameter to length aspect ratio is at most 0.1.

14. The apparatus as claimed in claim 13, wherein the length is at least 2 inches.

15. The apparatus as claimed in claim 14, wherein the deposit protrusions are detachable from the manifold.

16. The apparatus as claimed in claim 15, wherein the deposit protrusions and manifold are made of a dishwasher safe material.

17. The apparatus as claimed in claim 15, wherein the manifold is detachable from the container.

18. The apparatus as claimed in claim 15, wherein the deposit protrusions each present a male connection and the manifold presents a female connection corresponding to each male connection.

19. The apparatus as claimed in claim 18, wherein the male and female connections are screw-type connections.

20. An apparatus for depositing an ingredient into or onto an edible article, the apparatus comprising:
a container configured to hold the ingredient;
a manifold including an intake channel operable to receive at least one discrete intake flow, a distribution channel operable to divide the at least one discrete intake flow into at least two discrete output flows, and at least two output channels operable to deliver the at least two discrete output flows;
at least two deposit protrusions configured to deposit the at least two discrete output flows of ingredient into or onto the edible article; and
a valve operable to selectively stop or start the distribution of the at least one discrete intake flow.
